(19) United States
(12) Patent Application Publication
(10) Pub. No.: US 2008/0096444 A1
(43) Pub. Date: Apr. 24, 2008

(54) Optical Potentiometer And Control Lever Assembly

(75) Inventors: Mark Frederick Armstrong, Pascoe Vale South (AU); Peter John Major, Richmond (AU); Hans-Gunther Rosenkranz, Wantirna South (AU); Dmitri Shmatkov, Dandenong (AU)

Correspondence Address: BROMBERG & SUNSTEIN LLP, 125 SUMMER STREET, BOSTON, MA, 02110-1618, US

(73) Assignee: Aimbridge Pty Ltd, Melbourne (AU)

(21) Appl. No.: 11/793,128

(22) PCT Filed: Oct. 18, 2005
(86) PCT No.: PCT/AU05/01608

§ 371 Date: Jun. 13, 2007

(30) Foreign Application Priority Data
Dec. 15, 2004 (AU) 2004907143
Jul. 27, 2005 (AU) 2005904019

(51) Int. Cl. G01D 5/34; B63H 21/14

(52) U.S. Cl. 440/1; 250/229

(57) ABSTRACT

A control lever assembly having a potentiometer is disclosed which has a light emitter (14) and a light collector (15) with a screen (12) located between the emitter (14) and the collector (15). The screen is moveable with a control lever so that by providing varying translucency along the screen, the intensity of light received by the collector (15) changes to thereby provide a changing output signal. The screen (12) is connected to a lever mounted for rotation to move the screen relative to the collector and emitter. The assembly is provided with a housing (22) which has slots (24, 27) joined by an opening (29). The lever is moveable in the respective slots, or from one slot to another through the opening (29) to control different parameters of a marine propulsion system. The lever may have a handle (25) which is rotatable relative to the lever to adjust a further parameter.

### FIELD OF THE INVENTION

This invention relates to an optical potentiometer and a control lever assembly for controlling a marine propulsion system.

### BACKGROUND OF THE INVENTION

Conventional potentiometers generally comprise variable resistors. Such devices are used in a multitude of diverse electrical products to convert mechanical motion into a change in voltage or current. Conventional potentiometers usually consist of a conductive contact sliding against a winding of resistive wire, or a resistive track on a printed circuit board. Conventional potentiometers are therefore subject to wear and loss of contact, both of which can result in the production of an incorrect voltage having regard to the amount of relative movement between the contacting and moving parts of the potentiometer.

Conventional potentiometers are used in propulsion systems and, in particular, marine propulsion systems in order to provide control parameters. Such potentiometers suffer from the above disadvantage and it would therefore be desirable to provide a better potentiometer for use in a such a system. The invention also addresses control lever systems for use in marine propulsion systems which may use potentiometers or like devices for providing control signals.

A control system in which the lever assembly and potentiometers can be used is disclosed in our International Patent Application No. PCT/AU2004/001204. The contents of this International application are incorporated into this specification by this reference.

### SUMMARY OF THE INVENTION

The object of the present invention is to overcome this problem.

The present invention provides an optical potentiometer comprising:

a light emitter;

a light collector; and

a screen element for receiving light from the light emitter and providing the light to the light collector, the screen element being moveable relative to the light emitter and/or collector to change the amount of light received by the emitter dependent upon the relative position of the screen and emitter and/or collector.

Since the optical potentiometer uses the detection of light by the light collector provided from the screen, contacting parts are not required and therefore the optical potentiometer is not subject to wear and loss of contact, as is the case with conventional potentiometers. Thus, the optical potentiometer of the invention is able to provide more reliable readings over a longer period of time than conventional potentiometers.

In one embodiment of the invention, the screen element comprises a variable translucency screen element so that light is able to pass through the screen element from the light emitter to the light collector.

However, in other embodiments, the screen element may be a reflective element which may be provided with optical elements such as a diffraction grating for reflecting light dependent upon the relative position of the screen element and the light emitter and/or light collector.

In a still further embodiment, the screen element may comprise an element having openings through which light can pass and surface regions through which light is not able to pass.

Preferably the screen element is moveable so that, dependent upon the position of the screen element relative to the light emitter and light collector, an output voltage from the light collector provides an indication of the position of the screen element and therefore provides an output voltage for control of a machine.

In the preferred embodiment of the invention, the variable translucency screen element comprises a screen element having a plurality of spaced apart non-translucent and non-reflective regions so that light is able to pass between the non-translucent and non-reflective regions when the screen is moved relative to the light emitter and/or light collector.

Preferably the non-translucent and non-reflective regions are provided by parallel opaque lines of varying width.

Preferably the screen is in the form of a plastic strip.

The plastic strip may be straight or may be formed into a circular shape.

Preferably the strip has a transparent plastic substrate and a flexible film located on the substrate, the flexible film being provided with the opaque lines of varying width.

In the preferred embodiment of the invention, the light emitter and light collector are arranged stationary and the screen moves. However, in other embodiments the screen may be arranged stationary and the emitter and/or collector arranged for movement.

In one embodiment of the invention the optical potentiometer is provided in a boat control lever assembly. However, in other embodiments the potentiometer may be included in any environment where a variable voltage output is required upon variable movement of a component to control a machine or other article.

In the embodiment where the potentiometer is included in a lever control assembly, the screen is mounted on a cylinder which is in turn coupled to a control lever, the control lever being moveable to rotate the drum about a rotation axis, and the screen element being of circular configuration, the light emitter being provided on one side of the screen element and the light collector on the other side of the screen element so that the screen element rotates between the light emitter and light collector.

In this embodiment of the invention the control lever is also laterally moveable into at least two different positions and includes a sensor for sensing the lateral position of the control lever so that the control lever can be used to provide different types of control depending on the lateral position of the lever.

Preferably the sensor comprises one of a magnet or magnetic field detector located on the lever, and the other of the magnet or the magnetic field detector fixed to the assembly so that the magnetic field sensed by the detector changes depending on the lateral position of the lever.

Preferably the drum includes a plurality of detents for receiving a ball for facilitating movement of the lever to a predetermined position by movement of the ball over the detents.

Preferably a friction element is provided for engaging the drum to provide some resistance to movement of the drum in an adjusted position, depending on movement of the lever.

In some embodiments, a plurality of sets of light emitters and light collectors are provided so that if one set of light emitter and light collector fails, others are available to provide an output to provide a measure of the degree of movement of the potentiometer.

The invention may also be said to reside in a control lever assembly comprising:

a control lever;

mounting means for mounting the lever for rotation about a first axis and for lateral movement in the direction of the first axis, so that the control lever can be placed in a first lateral position or a second lateral position and then rotated in either position so that, depending on the lateral position of the lever, different parameters are controllable by the control lever;

a sensor for sensing the lateral position of the control lever;

a light emitter;

a light collector;

a screen element arranged between the light emitter and the light collector, and one of the light emitter, light collector, or screen element being coupled to the control lever for rotation with the control lever about the rotation axis; and

wherein movement of the control lever about the rotation axis changes the relative position of the screen element and the light emitter and light collector, so the light collector produces an output indicative of the position of the lever to thereby provide a control output to control the magnitude of one of the parameters, dependent upon the lateral position of the lever.

Preferably the screen is coupled to the control lever.

Preferably the mounting includes a drum and the screen is connected to the drum and is generally circular in shape so as to locate between the emitter and the collector.

In one embodiment of the invention, the control lever includes a handle fixed to the control lever for movement only with the control lever.

In a second embodiment which is applicable to twin engine systems (such as twin engine marine propulsion systems), the handle is moveable relative to the lever so that if the handle is moved with the lever, the system operates in the manner described above and both engines are synchronised but if the handle is moved relative to the lever, the engines of the twin engine system are individually controlled.

This embodiment therefore provides that the control lever has a handle and a shaft, the handle being rotatable relative to the shaft as well as moveable with the shaft, and a further sensor for sensing the position of the handle relative to the shaft for producing a further control signal to provide individual control of engines in a twin engine drive system.

Preferably the handle is mounted on the shaft for rotation relative to the shaft and the further sensor comprises:

a second light emitter;

a second light collector, the second light emitter and second light collector being coupled to one of the handle and shaft; and

a second screen element arranged between the second light emitter and the second light collector, and

the second screen element being coupled to the other of the handle and the shaft so that upon rotation of the handle, the second screen element moves relative to the second light emitter and the second light collector.

The invention also provides a control lever assembly for a twin engine propulsion system comprising:

a control lever having a handle and a shaft, the handle being moveable relative to the shaft;

mounting means for mounting the lever for rotation about a first axis and for lateral movement in the direction of the first axis, so that the control lever can be placed in a first lateral position or a second lateral position and then rotated in either position so that, depending on the lateral position of the lever, different parameters are controllable by the control lever;

a position sensor for sensing the lateral position of the control lever;

a first sensor for sensing the amount of movement of the control lever about the rotation axis and for producing an output indicative of the position of the lever to thereby provide a first control output to control the engines of the system, depending upon the lateral position of the lever; and

a second sensor for sensing the movement of the handle relative to the shaft for producing a second control output signal for independently controlling the engines in the twin engine system.

Preferably the position sensor comprises a Hall sensor for determining the lateral position of the control lever.

Preferably the first sensor comprises a potentiometer having a first light emitter, a first light collector, a first screen element arranged between the light emitter and the light collector, and one of the first light emitter and first light collector, and first screen element, being coupled to the control lever for rotation with the control lever about the rotation axis, and the second sensor comprising a second light emitter and a second light collector, and a second screen element arranged between the second light emitter and second light collector, and one of the light emitter and light collector, and screen element, being coupled to the shaft and the other of the second light emitter and second light collector, and second screen element, being coupled to the handle for rotation with the handle relative to the shaft.

Preferably the assembly comprises an outer housing having a first slot and a substantially parallel second slot spaced from the first slot, a passage connecting the first slot and the second slot and wherein the control lever is moveable about the rotation axis in either the first slot or the second slot and is moveable between the first and second slot through the passage by the lateral movement in the direction of the first axis.

### BRIEF DESCRIPTION OF THE DRAWINGS

A preferred embodiment of the invention will be described, by way of example, with reference to the accompanying drawings, in which:

FIG. 1 is a schematic view of a potentiometer according to the preferred embodiment of the invention;

FIG. 2 is a view of a boat control lever assembly in which the potentiometer of the invention can be used;

FIG. 3 is a cross-sectional view through the assembly of FIG. 2;

FIG. 4 is a view of part of the assembly of FIG. 3;

FIG. 5 is a block circuit diagram relating to the preferred embodiment of the invention;

FIG. 6 is a perspective cut away view of a second embodiment of the invention; and

FIG. 7 is a cross-sectional view of the embodiment of FIG. 6.

### DETAILED DESCRIPTION OF THE PREFERRED EMBODIMENT

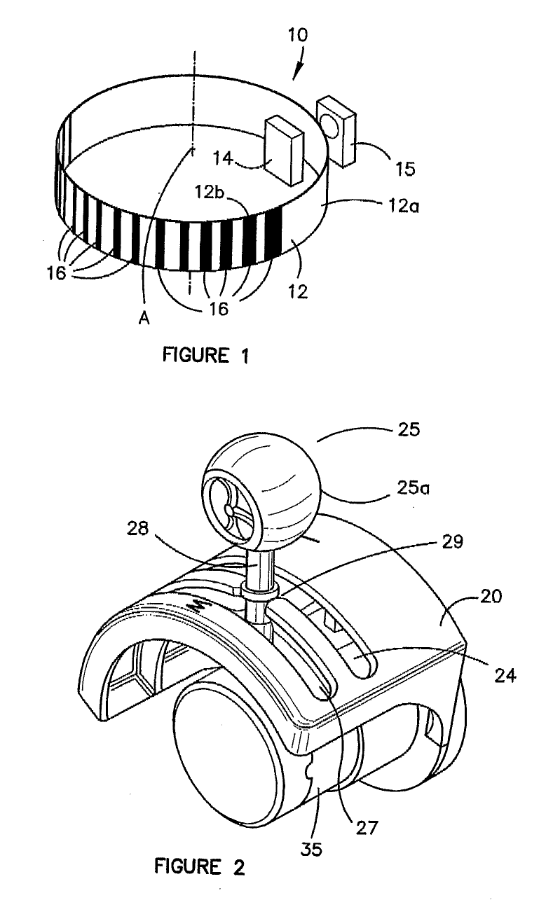

With reference to FIG. 1, a potentiometer 10 is shown which comprises a screen 12, a light emitter 14 and a light collector 15. The emitter 14 and collector 15 are mounted on a circuit board (not shown in FIG. 1) so that the emitter can be powered to output light at any desired wavelength and the collector powered to detect the light after the light has passed through the screen 12 and provide a voltage output dependent upon the amount of light which is detected by the collector. The voltage output can then be used as a control signal to control a machine or other article.

The screen 12 in the preferred embodiment of the invention is preferably circular in shape, as shown in FIG. 1. However, the screen 12 could be straight or linear and could be mounted for linear movement between the emitter 14 and collector 15 instead of for rotational movement, as is the case in FIG. 1.

In the preferred embodiment of the invention, the screen 12 is mounted for rotation about a central axis A so that the screen element moves between the emitter 14 and collector 15. The screen element 12 is preferably formed from a small section of clear plastic pipe or tubing to which is provided a laser exposed flexible film. The piping 12a provides a substrate for the film 12b so as to carry the film. The clear film 12b is provided with a bar-type pattern 16 of parallel black lines of varying width, as can be clearly seen in FIG. 1. The lines 16 may extend all the way about the periphery of the screen 12 or over only part of the periphery of the screen 12, as is shown in FIG. 1. Rather than use an exposed laser film, the screen 12 can simply be formed from suitable plastics or translucent material on which the bars 16 are printed. For most applications, the dimensions of the individual lines 16 and their spacing are preferably such that they are suitable for screen printing on the screen 12 either direct or via a film which allows for cheap mass production of the screen 12.

As the screen 12 is rotated relative to the emitter 14 and collector 15, the bars 16 come into registry with the emitter 14 and collector 15 and block some of the light passing from the emitter 14 to the collector 15. The amount of light which is transmitted will be dependent on the thickness of the bars 16 or, in other words, the amount of transparent or translucent region between the opaque bars 16. Thus, by the amount of light collected by the collector 15, the amount of rotation of the screen 12 is monitored and the voltage output from the collector 15 is dependent on the amount of light which is received, so that a voltage output from the collector 15 is provided, which is dependent upon the amount of rotation of the screen 12. In other embodiments the strip could be provided with increasing darkness or thickness to influence the amount of light blocked by the strip and which is transmitted to the collector 15.

The voltage signal may then be used as a control signal to control a machine or other article, dependent on the amount of rotation of the screen 12.

In one embodiment of the invention, the potentiometer shown in FIG. 1 is used in a boat lever control assembly shown in FIG. 2. The boat lever control assembly shown in FIG. 2 is provided for controlling a motor of the boat and a controllable pitch propeller driven by the motor.

As is shown in FIG. 2, the assembly comprises a generally curved outer housing 20 which has a pair of slots 24 and 27. A control lever 25 is mounted in the housing and includes a handle generally in the form of a ball 25a and a shaft 28. The shaft 28 connects with a rotatable drum 42 (not shown in FIG. 2) contained within an inner housing 22.

The slots 24 and 27 are also joined by an opening 29 so that the lever can not only be moved in the longitudinal direction of the slots 24 and 27 (that is around rotation axis A), but also laterally from one slot to another through the opening 29 to change the parameter of the boat which is being controlled by the lever 25.

For example, in the slot 24, the lever may control primarily engine speed and, to some extent, the pitch of the propeller and in the other slot 27, may primarily control the pitch of the propeller while limiting engine speed.

The collector 15 previously described is connected to a controller 30 which may be a microprocessor or other control system so that a variable voltage is provided to the controller 30, dependent upon the position of the lever 25 and therefore the position of the screen 12 so that the controller 30 receives the variable voltage and controls a parameter of the system, such as the speed of engine 32 or the pitch of propeller 34 by appropriate control signals output from the controller 30.

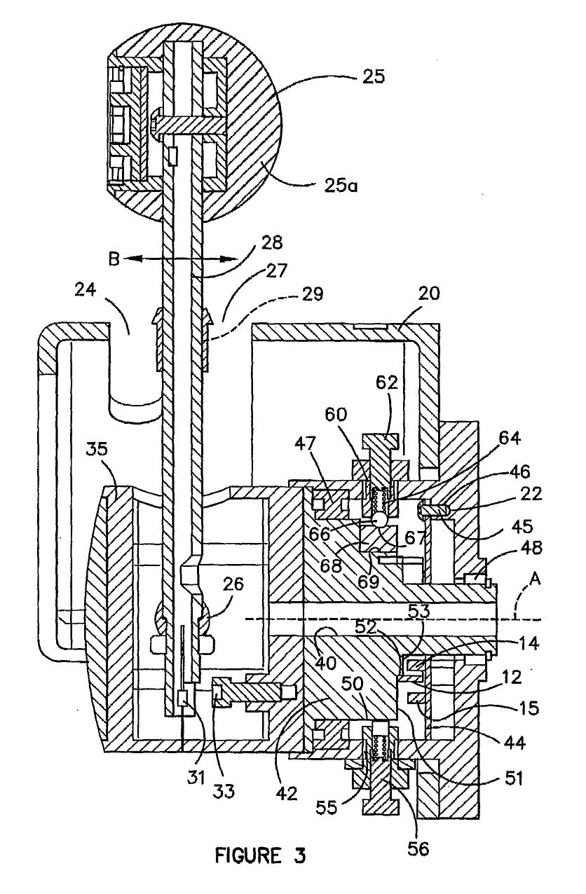

In FIG. 3, the assembly 20 is shown in generally vertical cross-section. Shaft 28 is connected to ball 25 in any suitable manner, and therefore will not be described in any detail herein. The shaft 28 is mounted on a pivot shaft 26 which allows lateral movement of the shaft 28 in the direction of double-headed arrow B in FIG. 3 (i.e. parallel to rotation axis A), so the shaft can be moved through the opening 29 to one of the slots 24 and 27, and then move longitudinally in those slots so that shaft 28 rotates about axis A.

The shaft 28 carries a magnet 31 and a magnetic field detector such as a coil or the like 33 is fixed to a head assembly 34 in which the shaft 28 projects, for lateral movement within the head assembly 34, and also for rotational movement in one of the slots 24 and 27 with the head 34.

Thus, when the shaft is moved to the slot 24, the magnet 33 is moved closer to the detector 31 and when the shaft is moved into the slot 27, the magnet 33 is moved further away from the detector 31. The detector 31 is therefore able to determine which of the slots 24, 27 the shaft is in, and therefore the nature of the control which is to be provided. For example, the detector 31 is connected to the controller 30, as shown in FIG. 5, and when it detects the low magnetic field indicative of the shaft 28 being in the slot 27, the controller 30 knows that the signals from the collector 15 are to be used to control the motor 32. When the detector 31 detects that the magnet 33 is close to the detector 31, indicative of the shaft 28 being in the slot 24, the controller 30 knows that the signals from the collector 15 are to be used to control the pitch of the propeller 34.

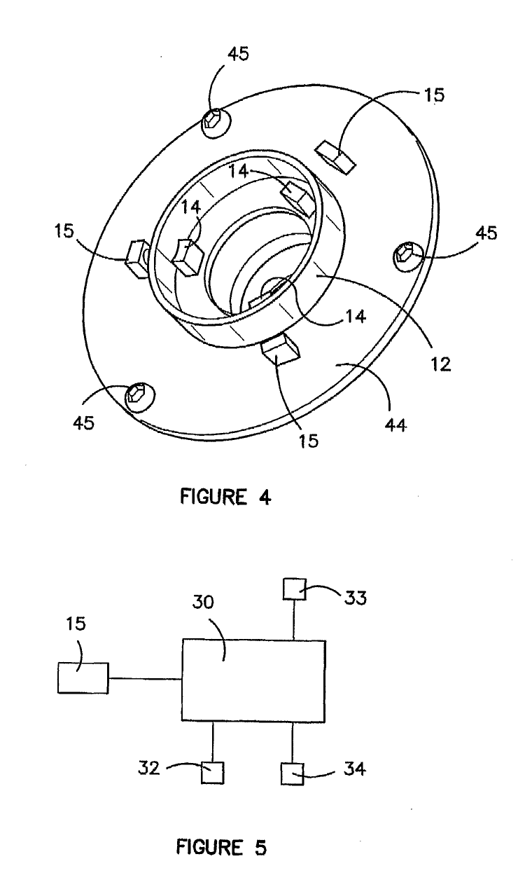

A mounting for the shaft 28 is formed of a head 35 and a drum 42. The head 35 is mounted on a hollow stem 40 which in turn carries the drum 42. The stem 44 can be formed by simple drilling into the cylinder 42. A circuit board 44 is fixed to the inner housing 22 and carries a plurality of sets of the emitters 14 and collectors 15 previously described. The hollow stem 40 is used to carry electrical cabling to the circuit board 44. The circuit board 44 having the sets of emitters 14 and collectors 15 is shown in perspective in FIG. 4. The circuit board 44 is secured to the inner housing 22 by screws 45 which locate in screw-threaded holes 46 (only one shown in FIG. 3) within the housing 22. The screen 12 is also shown in FIG. 4, although the screen 12 is not connected to the circuit board 44, as would be apparent from the previous description.

The drum 42 has a peripheral surface 50 and a side surface 51. The side surface 51 has a step 52 and a further side surface 53 is offset from the surface 51. The screen 12 is connected to the step 52 by adhesive or any other suitable fixing method so that the screen 12 locates between the emitter 14 and the collector 15, as described with reference to FIG. 1. The drum 42 is journaled in bearings 47 and bush 48 so that when the shaft 28 is moved in one of the slots 24 or 27, the head 34 together with the drum 42 is rotated in the housing 22 to in turn rotate the screen 12 between the sets of emitters 14 and collectors 15. Thus, depending on the degree of movement of the lever 25, the black bars on the screen 12 will move into proximity between the emitter 14 and collector 15 and depending on the amount of light received by the collector 15, the voltage output from the collector 15 will change to thereby provide the required control signals to the controller 30 to control the motor 32 or propeller 34, as is required by the operator of the lever 25.

The inner housing 22 may be provided with a hole 55 which receives a spring loaded stud 56 which bears against the surface 50 to provide some frictional resistance to movement of the drum 42 to hold the drum 42 in an adjusted place during operation of the boat. A second hole 60 may also be provided which receives a second stem 62 which carries a spring 64 and a ball 66. The ball 66 is locatable in one of a plurality of detents 67 within an arcuate block 68 located in a recess portion 69 of the drum 64. This simply provides a degree of feel to movement of the lever 25 and to make it easier to stop the lever 25 in a desired position when a particular boat speed or pitch condition of the propeller is achieved.

In one embodiment of the invention the nature of the voltage signal outputs by the various sets of emitters 14 and collectors 15 shown in FIG. 4 can be different or can be differently processed by circuitry on the circuit board 44 so that if one set should fail, the controller 30 is able to determine which set has actually failed and therefore rely on the other sets in order to provide the required control based on the voltage signal which is received. The screen 12 can have three sets of marking—one for each set of collectors and emitters.

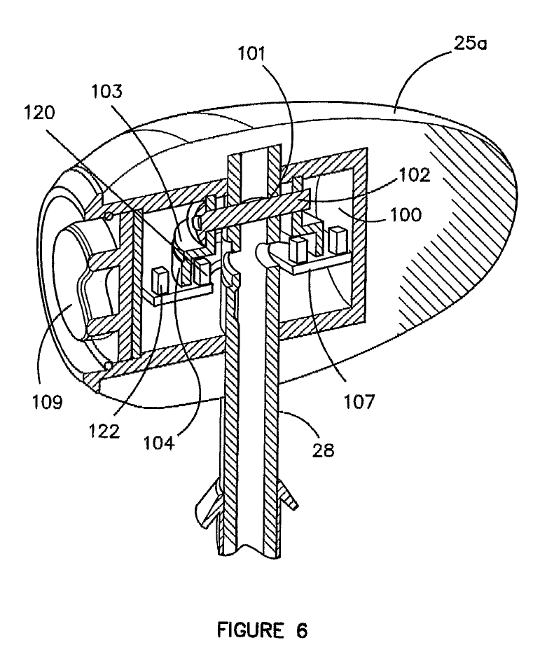

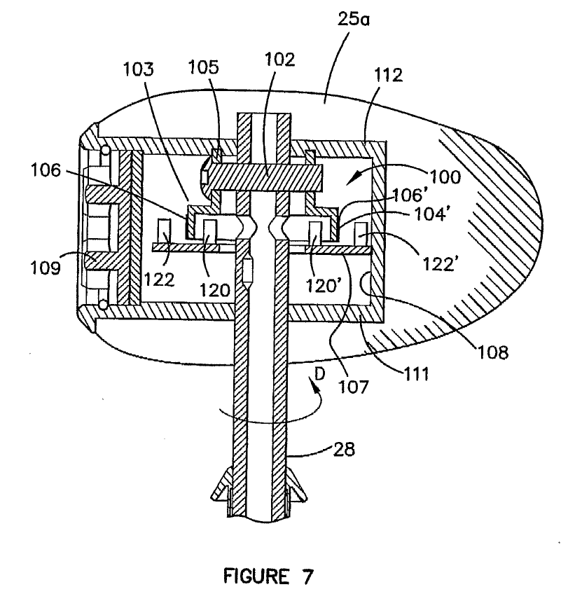

FIGS. 6 and 7 show a second embodiment of the invention which is for the control of a twin engine system of a marine propulsion system. The difference between this embodiment and the previous embodiment is mainly concerned with the configuration of the handle 25a and its connection with the shaft 28. In this embodiment, the housing 20 and the componentry within the housing 20 is similar to that in the earlier embodiment.

With reference to FIGS. 6 and 7, handle 25a is of egg shape or the like and has a cavity 100 through which shaft 28 passes. The shaft 28 has a hole 101 for receiving a pin 102 which connects a drum 103 to the shaft 28 so the drum 103 is fixed to the shaft 28. As is best seen in FIG. 7, the drum 103 has a transparent large diameter portion 104 and a smaller diameter portion 105 through which the pin 102 passes. The large diameter portion 104 carries a screen element 106 which is similar to the screen element 12 previously described and has two printed sections for the two emitter-collector configurations to be described hereinafter.

A circuit board 107 is fixed in the cavity 100 by having a tongue (not shown) which is received in a slot (not shown) in end wall 108 of the cavity 100. The cavity 100 is closed by a closure plate assembly 109 which may also carry a further circuit board (not shown). If desired, the other end of the circuit board 107 can be fixed to the further circuit board carried by the closure 109 or can attach to the closure 109 in the same manner as it attaches to the end wall 108.

The handle 25a is mounted for rotation on the shaft 28 so the handle 25a can rotate, as shown by arrow D in FIG. 7, about the shaft 28. A bush (not shown) may be provided on the shaft 28 and extend along the shaft 28 between bottom wall 111 and top wall 112 of the cavity 100 or further down to stabilise the handle 25a so it does not rattle or feel loose and is only moveable by rotation about the shaft 28 or with the shaft 28.

In order to operate the twin engine system, the handle 25a and shaft 28 are moved in the same manner as described with reference to FIG. 1 without any rotation of the handle 25a relative to the shaft 28. In order to provide independent control of the engines in the twin engine system, the handle 25a is rotated relative to the shaft 28 in the direction of arrow D or in the opposite direction, so that the drum 103 and therefore the screen element 106 move relative to the circuit board 107. In the embodiment shown, it is the circuit board 107 which is rotated so that the relative movement takes place. However, in other embodiments the drum 103 could be mounted so that it rotates with the handle 25a whilst the circuit board 107 remains fixed to the shaft 28.

The circuit board 107 has a light emitter 120 and a light collector 122 between which the screen 106 locates. By rotating the handle 25a, the screen 106 is moved to alter the amount of light which is received by the collector 122 so the collector 122 can provide a control signal indicative of the amount of rotation of the handle 25a relative to the shaft 28.

Another light emitter 120′ and light collector 122′ can be provided, together with second portion 106′ to provide a check that the system comprised of the light emitters and collectors and screen elements is operating properly. Thus, the two sets of light emitters and collectors and screen elements produce signals which are proportional to the amount of twist or rotation of the handle 25a relative to the shaft 28. If the signals from the two sets of light emitters and light collectors and screen elements are not indicating identical angular movements of the handle 25a, the system determines that there is a fault with the system and effectively shuts off the control from the output signals produced by the embodiment of FIGS. 6 and 7 and operates only on the control produced by the rotational movement of the shaft 28 so the boat having the system can limp home with synchronised engines if needed.

In the twin engine system, when the shaft 28 is moved laterally to control the usual speed of the boat, the engines are synchronised and run at identical speeds according to the position of the lever 28. If the lever 28 is moved in the direction of the rotational axis so as to place the system in maneuvering mode rather than cruise mode, the speed demand for both engines is calculated from a combination of the angular movement of the shaft 28 about the rotation axis and an offset determined by the rotation or twist angle of the handle 25a relative to the shaft 28. The engine throttles are set as a combination of the forward and backward movement of the shaft 28a about the rotation axis, as well as clockwise or anticlockwise rotation of the handle 25a.

For example, if the main lever angle is zero and the handle is twisted 30% of the range counter clockwise, the port engine speed demand would be 30% of the maximum delta speed with the left engine clutch engaged in reverse (or the pitch in reverse for pitch control system). The right hand engine would also be set to 30% throttle, but with the clutch in forward. If the main lever position is 50% forward and the twist angle is 10% counter clockwise, the port engine is set to 50% of the maximum maneuvering speed minus 10% of the maximum delta speed. Starboard engine setting stays the same at 50%. If the handle is twisted clockwise, the starboard engine speed is reduced and the port engine stays at 50% according to the main lever position.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

1. An optical potentiometer comprising:
a light emitter;
a light collector; and
a screen element for receiving light from the light emitter and providing the light to the light collector, the screen element being moveable relative to the light emitter and/or collector to change the amount of light received by the emitter dependent upon the relative position of the screen and emitter and/or collector.

2. The potentiometer of claim 1 wherein the screen element comprises a variable translucency screen element so that light is able to pass through the screen element from the light emitter to the light collector.

3. The potentiometer of claim 1 wherein the screen element is moveable so that, dependent upon the position of the screen element relative to the light emitter and light collector, an output voltage from the light collector provides an indication of the position of the screen element and therefore provides an output voltage for control of a machine.

4. The potentiometer of claim 2 wherein the variable translucency screen element comprises a screen element having a plurality of spaced apart non-translucent and non-reflective regions so that light is able to pass between the non-translucent and non-reflective regions when the screen is moved relative to the light emitter and/or light collector.

5. The potentiometer of claim 4 wherein the non-translucent and non-reflective regions are provided by parallel opaque lines of varying width.

6. The potentiometer of claim 1 wherein the screen is in the form of a plastic strip.

7. The potentiometer of claim 6 wherein the strip has a transparent plastic substrate and a flexible film located on the substrate, the flexible film being provided with the opaque lines of varying width.

8. The potentiometer of claim 1 wherein the light emitter and light collector are arranged stationary and the screen moves.

9. The potentiometer of claim 1 wherein the optical potentiometer is provided in a boat control lever assembly.

10. The potentiometer of claim 9 wherein the potentiometer is included in a lever control assembly, the screen is mounted on a cylinder which is in turn coupled to a control lever, the control lever being moveable to rotate the drum about a rotation axis, and the screen element being of circular configuration, the light emitter being provided on one side of the screen element and the light collector on the other side of the screen element so that the screen element rotates between the light emitter and light collector.

11. The potentiometer of claim 10 wherein the control lever is also laterally moveable into at least two different positions and includes a sensor for sensing the lateral position of the control lever so that the control lever can be used to provide different types of control depending on the lateral position of the lever.

12. The potentiometer of claim 1 wherein the sensor comprises one of a magnet or magnetic field detector located on the lever, and the other of the magnet or the magnetic field detector fixed to the assembly so that the magnetic field sensed by the detector changes depending on the lateral position of the lever.

13. The potentiometer of claim 1 wherein the drum includes a plurality of detents for receiving a ball for facilitating movement of the lever to a predetermined position by movement of the ball over the detents.

14. The potentiometer of claim 1 wherein a friction element is provided for engaging the drum to provide some resistance to movement of the drum in an adjusted position, depending on movement of the lever.

15. The potentiometer of claim 1 wherein a plurality of sets of light emitters and light collectors are provided so that if one set of light emitter and light collector fails, others are available to provide an output to provide a measure of the degree of movement of the potentiometer.

16. A control lever assembly comprising:
a control lever;
mounting means for mounting the lever for rotation about a first axis and for lateral movement in the direction of the first axis, so that the control lever can be placed in a first lateral position or a second lateral position and then rotated in either position so that, depending on the lateral position of the lever, different parameters are controllable by the control lever;
a sensor for sensing the lateral position of the control lever;
a light emitter;
a light collector;
a screen element arranged between the light emitter and the light collector, and one of the light emitter, light collector, or screen element being coupled to the control lever for rotation with the control lever about the rotation axis; and
wherein movement of the control lever about the rotation axis changes the relative position of the screen element and the light emitter and light collector, so the light collector produces an output indicative of the position of the lever to thereby provide a control output to control the magnitude of one of the parameters, dependent upon the lateral position of the lever.

17. The assembly of claim 16 wherein the screen is coupled to the control lever.

18. The assembly of claim 16 wherein the mounting includes a drum and the screen is connected to the drum and is generally circular in shape so as to locate between the emitter and the collector.

19. The assembly of claim 16 wherein the control lever includes a handle fixed to the control lever for movement only with the control lever.

20. The assembly of claim 16 wherein the handle is moveable relative to the lever so that if the handle is moved with the lever, the system operates in the manner described above and both engines are synchronised but if the handle is moved relative to the lever, the engines of the twin engine system are individually controlled.

21. The assembly of claim 20 wherein the control lever has a handle and a shaft, the handle being rotatable relative to the shaft as well as moveable with the shaft, and a further sensor for sensing the position of the handle relative to the shaft for producing a further control signal to provide individual control of engines in a twin engine drive system.

22. The assembly of claim 21 wherein the handle is mounted on the shaft for rotation relative to the shaft and the further sensor comprises:
a second light emitter;
a second light collector, the second light emitter and second light collector being coupled to one of the handle and shaft; and
a second screen element arranged between the second light emitter and the second light collector, and the second screen element being coupled to the other of the handle and the shaft so that upon rotation of the handle, the second screen element moves relative to the second light emitter and the second light collector.

23. A control lever assembly for a twin engine propulsion system comprising:
a control lever having a handle and a shaft, the handle being moveable relative to the shaft;
mounting means for mounting the lever for rotation about a first axis and for lateral movement in the direction of the first axis, so that the control lever can be placed in a first lateral position or a second lateral position and then rotated in either position so that, depending on the lateral position of the lever, different parameters are controllable by the control lever;
a position sensor for sensing the lateral position of the control lever;
a first sensor for sensing the amount of movement of the control lever about the rotation axis and for producing an output indicative of the position of the lever to thereby provide a first control output to control the engines of the system, depending upon the lateral position of the lever; and
a second sensor for sensing the movement of the handle relative to the shaft for producing a second control output signal for independently controlling the engines in the twin engine system.

24. The assembly of claim 23 wherein the position sensor comprises a Hall sensor for determining the lateral position of the control lever.

25. The assembly of claim 23 wherein the first sensor comprises a potentiometer having a first light emitter, a first light collector, a first screen element arranged between the light emitter and the light collector, and one of the first light emitter and first light collector, and first screen element, being coupled to the control lever for rotation with the control lever about the rotation axis, and the second sensor comprising a second light emitter and a second light collector, and a second screen element arranged between the second light emitter and second light collector, and one of the light emitter and light collector, and screen element, being coupled to the shaft and the other of the second light emitter and second light collector, and second screen element, being coupled to the handle for rotation with the handle relative to the shaft.

26. The assembly of claim 23 wherein the assembly comprises an outer housing having a first slot and a substantially parallel second slot spaced from the first slot, a passage connecting the first slot and the second slot and wherein the control lever is moveable about the rotation axis in either the first slot or the second slot and is moveable between the first and second slot through the passage by the lateral movement in the direction of the first axis.
